(19) United States
(12) Patent Application Publication
(10) Pub. No.: US 2012/0075769 A1
(43) Pub. Date: Mar. 29, 2012

(54) HIGH TEMPERATURE HIGH CURRENT METALIZED FILM CAPACITOR

(76) Inventors: Edward M. Lobo, North Dartmouth, MA (US); Paul Winsor, IV, Somerset, MA (US)

(21) Appl. No.: 12/893,696

(22) Filed: Sep. 29, 2010

(51) Int. Cl. H01G 4/32

(52) U.S. Cl. 361/301.5

(57) ABSTRACT

A rolled film capacitor includes a first dielectric layer of high crystallinity polypropylene and a first metalized electrode stack adjacent to and contacting the first dielectric layer. The first metalized electrode stack includes a first substrate located between first and second metallic films. The capacitor also includes a second dielectric layer of high crystallinity polypropylene, and a second metalized electrode stack adjacent to and contacting the second dielectric layer, the second metalized electrode stack comprising a second substrate located between third and fourth metallic films.

### FIELD OF THE INVENTION

The invention relates to film capacitors, and in particular to a high temperature, high current rolled film capacitor.

### BACKGROUND OF THE INVENTION

In typical rolled (i.e., wound) capacitors with electrodes made of solid metal foils, damage to the dielectric system during manufacture (resulting from, e.g., local imperfections in the dielectric, irregularities in the electrodes, or foreign particles) may cause the capacitor to break down when energized, rendering it unusable. So-called self-clearing capacitors use metallized electrodes, each composed of a dielectric backing (e.g., paper or polypropylene), coated with a thin metal layer. When an appropriate voltage is applied, the metal is vaporized or converted to a nonconductive metal oxide at points were defects exist. Conduction through the dielectric is thereby eliminated at damaged places, rendering the capacitor usable. However, a problem with these capacitors is their relatively limited temperature range.

There is a need for a high current rolled film capacitor capable of operating at high temperatures.

### SUMMARY OF THE INVENTION

A rolled film capacitor includes a first dielectric layer of high crystallinity polypropylene and a first metalized electrode stack adjacent to and contacting the first dielectric layer. The first metalized electrode stack includes a first substrate located between first and second metallic films. The capacitor also includes a second dielectric layer of high crystallinity polypropylene, and a second metalized electrode stack adjacent to and contacting the second dielectric layer, the second metalized electrode stack comprising a second substrate located between third and fourth metallic films.

The crystallinity of the high crystallinity polypropylene 108 is above 50%, for example at least 52%, preferably at least about 55%, and most preferable above about 57%. In addition, the polypropylene may have an isotacticity great than about 98%.

The metalized electrodes may be aluminum, zinc, gallium, an alloy of aluminum or zinc, copper, or in general a metal having a low temperature of vaporization.

The first and second substrate material is preferably PET. However, the substrate may also be a polycarbonate. In general, since the substrate is not being used for its electrical properties, it may be any compatible material that is mechanically stable at the elevated temperature up to about 125° C.

The wound capacitor may be located in a housing, with or without liquid within the housing surrounding the wound capacitor.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 is a perspective view of a wound capacitor, removed from its housing and partially unwound;

FIG. 2 is a partial cross sectional view of the capacitor of FIG. 1 that uses a one-series double metalized PET electrode structure; and

FIG. 3 is a partial cross sectional view of an alternative embodiment capacitor that uses a four-series double metalized PET electrode structure.

### DETAILED DESCRIPTION OF THE INVENTION

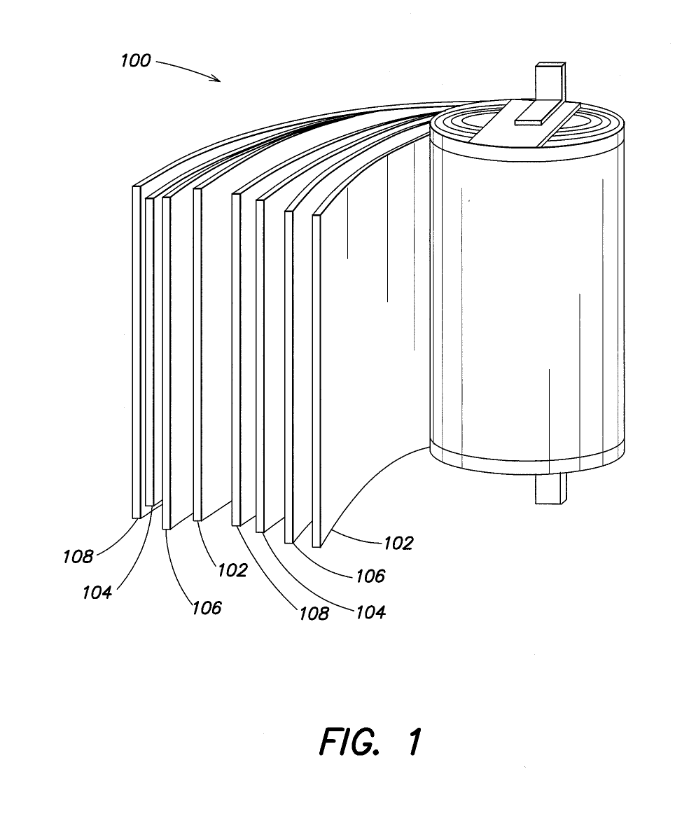

FIG. 1 is a perspective view of a wound capacitor 100, removed from its housing (not shown) and partially unwound. The wound capacitor may be located within a housing (e.g., cylindrical), with or without liquid within the housing and surrounding the wound capacitor.

The capacitor 100 includes two generally planar metalized electrodes 102, 104. The electrodes 102, 104 are preferably vapor deposited, and formed for example of aluminum or zinc, and have a thickness of about 200-300 Angstroms. The electrodes 102, 104 are separated by and each in contact with a substrate 106, preferably of polyethylene terephthalate (PET), thus forming a stack of double metalized PET. The capacitor 100 also includes a layer of high crystalline polypropylene film 108 that forms a dielectric. The layers 102, 104, 106, 108 are wound around a central core, and thus radially repeat.

Conventional polypropylene used as a dielectric has a degree of crystallization that is typically above 50%. However, in contrast, the high crystalline polypropylene film 108 used as the dielectric has an average increase in crystallinity of about 3-4% beyond that of the conventional polypropylene crystallinity. Thus the crystallinity of the film 108 is above 50%, for example at least 52%, preferably at least about 54%, and most preferable above about 56%. In addition, the high crystallinity polypropylene may have an isotacticity great than about 98%.

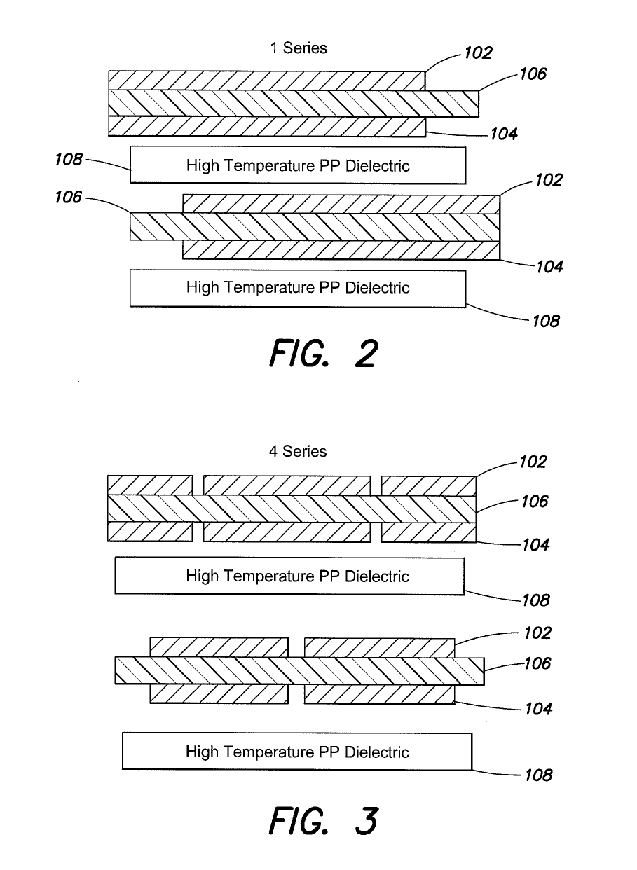

FIG. 2 is a partial cross sectional view of the capacitor 100 of FIG. 1, with a one-series double metalized electrode structure.

FIG. 3 is a partial cross sectional view of an alternative embodiment capacitor 300 that that uses a four-series double metalized electrode structure. It is contemplated that various other series structures may be used for the double metalized electrode structure.

The stack of double metalized PET that includes the electrodes 102, 104 and the PET substrate 106 are generally commercially available as a prewound stack. This prewound stack can then be unwound and rewound together with the layer of high crystalline polypropylene film 108 to form the repeating four-layer structure illustrated in FIGS. 1-3.

The double metalized PET stack provides the advantages of self healing with high temperature stability, yet because the PET substrate is double metalized the substrate does not add any substantial dissipation factor to the capacitor. In addition, the capacitor has been shown to operate at high temperature (e.g., 125° C.). Thus the capacitor employing double metalized PET for electrodes and a high crystallinity polypropylene dielectric has been shown to provide the advantageous operational features of high current, high temperature and self healing.

In an alternative embodiment, the substrate may be a polycarbonate. In general, since the substrate is not being used for its electrical properties, it may be any compatible material that is mechanically stable at the elevated temperature up to about 125° C.

In addition, alternative metalized electrodes include gallium, an alloy of aluminum or zinc, copper, or in general a metal having a low temperature of vaporization.

Although the present invention has been illustrated and described with respect to several preferred embodiments thereof, various changes, omissions and additions to the form and detail thereof, may be made therein, without departing from the spirit and scope of the invention.

What is claimed is:

1. A rolled film capacitor, comprising:
a first dielectric layer of polypropylene having a crystallinity above 60%;
a first metalized electrode stack adjacent to and contacting the first dielectric layer, the first metalized electrode stack comprising a first substrate located between first and second metallic films;
a second dielectric layer of polypropylene having a crystallinity above 60%; and
a second metalized electrode stack adjacent to and contacting the second dielectric layer, the second metalized electrode stack comprising a second substrate located between third and fourth metallic films.

2. The film capacitor of claim 1, where the first dielectric layer has a crystallinity of at least about 63%.

3. The film capacitor of claim 1, where the second dielectric layer has a crystallinity of at least about 63%.

4. The film capacitor of claim 2, where the first substrate comprises polyethylene terephthalate (PET).

5. The film capacitor of claim 4, where the first metallic film comprises aluminum.

6. The film capacitor of claim 4, where the first metallic film comprises zinc.

7. The film capacitor of claim 1, where the first dielectric layer has a crystallinity of at least about 62%.

8. The film capacitor of claim 1, where the second dielectric layer has a crystallinity of at least about 62%.

9. The film capacitor of claim 1, where the first dielectric layer has a crystallinity of at least about 64%.

10. The film capacitor of claim 1, where the second dielectric layer has a crystallinity of at least about 64%.

11. The film capacitor of claim 1, where the first dielectric layer has a crystallinity of at least about 65%.

12. The film capacitor of claim 1, where the second dielectric layer has a crystallinity of at least about 65%.

13. The film capacitor of claim 1, where the first dielectric layer has a crystallinity of at least about 67%.

14. The film capacitor of claim 1, where the second dielectric layer has a crystallinity of at least about 67%.

15. The film capacitor of claim 1, where the first metallic film has a thickness of about 200-300 Angstroms.

16. A rolled film capacitor, comprising:
a first dielectric film of high crystallinity polypropylene having an isotacticity great than about 98%;
a first metalized electrode stack adjacent to and contacting the first dielectric film, the first metalized electrode stack comprising a first substrate located between first and second metallic films;
a second dielectric film of high crystallinity polypropylene; and
a second metalized electrode adjacent to and contacting the second dielectric film, the second metalized electrode comprising a second substrate located between third and fourth metallic films.

17. A rolled film capacitor, comprising:
a first dielectric layer of polypropylene having a crystallinity above 50%;
a first metalized electrode stack adjacent to and contacting the first dielectric layer, the first metalized electrode stack comprising a first substrate located between first and second metallic films;
a second dielectric layer of polypropylene having a crystallinity above 50%; and
a second metalized electrode stack adjacent to and contacting the second dielectric layer, the second metalized electrode stack comprising a second substrate located between third and fourth metallic films.

18. The film capacitor of claim 17, where the first dielectric layer has a crystallinity of at least about 53%.

19. The film capacitor of claim 17, where the second dielectric layer has a crystallinity of at least about 53%.

20. The film capacitor of claim 18, where the first substrate comprises polyethylene terephthalate (PET).

21. The film capacitor of claim 20, where the first metallic film comprises aluminum.

22. The film capacitor of claim 20, where the first metallic film comprises zinc.

23. The film capacitor of claim 17, where the first dielectric layer has a crystallinity of at least about 52%.

24. The film capacitor of claim 17, where the second dielectric layer has a crystallinity of at least about 52%.

25. The film capacitor of claim 17, where the first dielectric layer has a crystallinity of at least about 54%.

26. The film capacitor of claim 17, where the second dielectric layer has a crystallinity of at least about 54%.

27. The film capacitor of claim 17, where the first dielectric layer has a crystallinity of at least about 55%.

28. The film capacitor of claim 17, where the second dielectric layer has a crystallinity of at least about 55%.

29. The film capacitor of claim 17, where the first dielectric layer has a crystallinity of at least about 57%.

30. The film capacitor of claim 17, where the second dielectric layer has a crystallinity of at least about 57%.

31. The film capacitor of claim 17, where the first metallic film has a thickness of about 200-300 Angstroms.
